(19) United States
(12) Patent Application Publication
(10) Pub. No.: US 2015/0050984 A1
(43) Pub. Date: Feb. 19, 2015

(54) Method for Operating a Gaming Machine

(71) Applicant: Bally Gaming, Inc., Las Vegas, NV (US)

(72) Inventor: Gautam Parameshwar Hegde, Bangalore (IN)

(21) Appl. No.: 14/337,660

(22) Filed: Jul. 22, 2014

Related U.S. Application Data
(60) Provisional application No. 61/865,496, filed on Aug. 13, 2013.

(51) Int. Cl. G07F 17/34; G07F 17/32

(52) U.S. Cl. CPC G07F 17/34; G07F 17/3213
USPC 463/20

(57) ABSTRACT

A gaming device includes a game initiation device. A set of base game results each includes a predetermined number of symbols including base game symbols and zero or more bonus game symbols. Each base game result is associated with a base game award. A base game randomly selects a base game result from the set of base game results in response to activation of the game initiation device, and awards the base game award associated with the base game result to the player. If the base game result includes more than a predetermined number of bonus game symbols, a bonus game is initiated. A bonus game randomly selects a number of base game symbols equal to the number of bonus game symbols in the base game result and substitutes the selected base game symbols for the bonus game symbols in the base game results to produce a bonus game result and awards the base game award associated with the bonus game result.

### CROSS-REFERENCE TO RELATED APPLICATION

This application claims priority to Provisional Application No. 61/865,496, filed Aug. 13, 2013 and is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Field of the Invention

This invention pertains generally to the a gaming device and more particularly to a bonus game on a gaming machine.

2. The Prior Art

Gaming machines are known in which bonus games are awarded based on the play of a base game. In some cases, the base game includes a plurality of columns or reels each including a plurality of reel symbols. Some of the reel symbols are special bonus symbols. If, at the end of a base game play, a specified number of special bonus symbols appear on the game display, possibly in specified locations, then a bonus game is awarded to the player. In some gaming machines, the results of the base game affect the playing of the bonus game. For example, in some gaming machines, the specific bonus symbol displayed determines the bonus game which is awarded to the player.

Still, however, players enjoy increased interaction with the gaming machine and a feeling that they are controlling the flow of the game. A bonus game which includes increased interaction with the player increases the excitement level. Such a bonus game is desirable.

### BRIEF DESCRIPTION OF THE INVENTION

In accordance with principles of the present invention a gaming device includes a game initiation device. The gaming device also includes a set of base game results each including a predetermined number of symbols including base game symbols and zero or more bonus game symbols. Each base game result is also associated with a base game award. The gaming device also includes a base game which randomly selects a base game result from the set of base game results in response to activation of the game initiation device, and awards the base game award associated with the base game result to the player. If the base game result includes more than a predetermined number of bonus game symbols, a bonus game is initiated. The bonus game randomly selects a number of base game symbols equal to the number of bonus game symbols in the base game result and substitutes the selected base game symbols for the bonus game symbols in the base game results to produce a bonus game result and awards the base game award associated with the bonus game result.

### BRIEF DESCRIPTION OF THE DRAWING

FIG. 1 is a block diagram of a gaming machine according to principles of the present invention.

FIG. 2 is a representation of a display of a gaming machine illustrating the end of the play of a base game according to the present invention;

FIG. 3 is a representation of a display of a gaming machine illustrating a first part of a bonus game according to the present invention;

FIGS. 4A, 4B and 4C are representations of a display of a gaming machine illustrating the end of play of a bonus game according to the present invention;

FIG. 5 is a perspective view of a gaming machine in accordance with the present invention;

FIGS. 6A and 6B are block diagrams of the physical and logical components of the gaming machine of FIG. 5 in accordance with the present invention;

FIG. 7 is a block diagram of the logical components of a gaming kernel in accordance with the present invention;

FIGS. 8A and 8B are schematic blockdiagrams showing the hardware elements of a networked gaming system in accordance with the present invention; and

FIG. 9 is a is a diagram showing an example of an architecture for tying a casino enterprise network to an external provider of games and content to Internet or broadband communication capable devices according to the present invention.

### DETAILED DESCRIPTION OF THE PREFERRED EMBODIMENTS

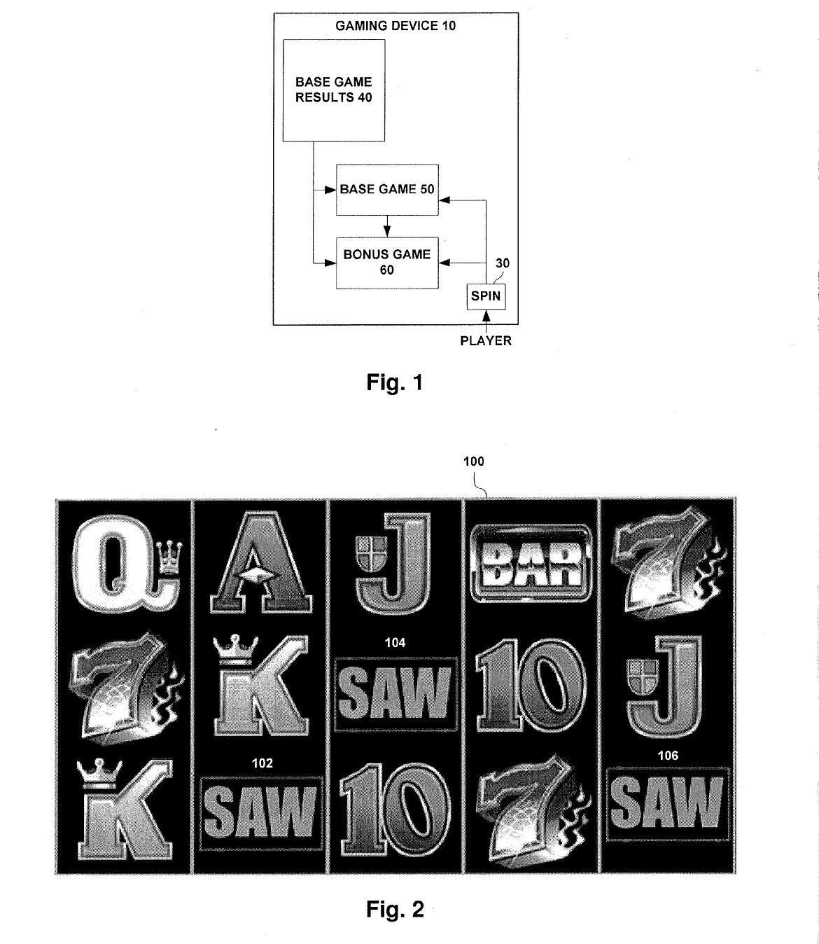

FIG. 1 is a block diagram of a gaming device 10 in accordance with principles of the present invention. In FIG. 1, the gaming device 10 includes a set of base game results 40. Each base game result in the set of base game results includes a predetermined number of symbols, as illustrated and described below. The predetermined number of symbols include base game symbols and zero or more bonus game symbols. At least one of the base game results include special bonus symbols. Each base game result is also associated with a base game award. The base game award may be zero.

The gaming device 10 further includes a game initiation device 30. The game initiation device may be a physical or video button, which may have the word “SPIN” or “PLAY” or similar inscribed on it. Alternatively, or in addition, the game initiation device may include a lever, and/or any other suitable means. The game initiation device 30 further interacts with means (not shown) for accepting value for wagering, accepting an amount of a wager from the player, and enabling game play only when a wager has been received from the player. These means are not germane to the present invention and are not described in detail. However, one skilled in the art understands what these means are, and how do design, implement, and/or to interact with these means.

The gaming device 10 further includes a base game 50 and a bonus game 60. The base game 50 randomly selects a base game result from the set of base game results 40 in response to activation of the game initiation device 30. At the conclusion of the play of the base game, the base game award (which may be zero) associated with the base game result is awarded to the player. If the base game result includes more than a predetermined number of bonus game symbols, then a bonus game is initiated.

The bonus game 60 randomly selects a number of base game symbols equal to the number of bonus game symbols in the base game result. The selected base game symbols are substituted for the bonus game symbols in the base game result to produce a bonus game result. The base game award associated with the base game result corresponding to the bonus game result is awarded to the player.

FIG. 2 is a representation 100 of a display of a gaming machine at the completion of a play of the base game. In FIG. 2, five reels or columns are displayed each including a plurality of reel symbols. Three adjacent reel symbols from each reel or column are displayed on a display device representing a base game result. Consequently, the predetermined number of symbols in a base game result is 15 symbols. One skilled in the art understands that any number of reels, and any number of reel symbols on each reel may be used.

Among the reel symbols on the reels are special bonus symbols, which are represented by rectangles with “SAW” inside them. A player plays a base game in a known manner by entering a wager amount, and activating the base game. In the exemplary game, the reels spin, then stop, displaying five reels with three reel symbols each, representing a base game result. In FIG. 2, three special bonus symbols (102, 104 and 106) appear on the display, thereby awarding a bonus game.

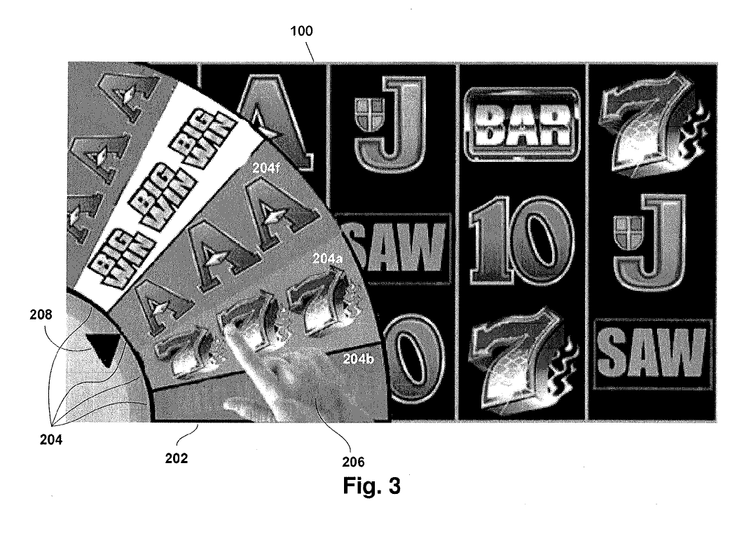

FIG. 3 is a representation 100 of a display of a gaming machine illustrating a first part of a bonus game. The bonus game includes a spinning wheel 202. The wheel 202 includes a plurality of segments 204. One or more of the segments 204 contain reel symbols (e.g. “A”, “J”, “BAR”, “10”, “7”, etc.) from the base game. The contents of the wheel 202 are dynamically generated at the beginning of each bonus game. In the illustrated embodiment, the number of reel symbols in each segment 204 is equal to the number of special bonus symbols “SAW” on the display at the end of the preceding base game. For example, in FIG. 3, a “7” is one of the reel symbols in the base game; and one segment 204a on the wheel 202 contains “7”, “7”, “7”. While the base game reel symbols illustrated in each segment of the wheel in FIG. 3 are the same, the reel symbols within a segment may be different.

To start the bonus game, a player initiates a wheel spin by using his hand 206 on the display touch screen to turn the wheel, or may use one or more player input devices, such as push buttons, video buttons, or lever, to initiate spinning of the wheel. Once spun, the wheel slows and stops. A pointer 208 indicates the final selected segment when the wheel stops. For example, in FIG. 3 assume that after the spin is complete, the final selected segment is 204a and includes reel symbols “7”, “7”, “7”. The reel symbols (“7”, “7”, “7”) on the final selected segment (204a) are substituted for the special bonus symbols “SAW” in the base game in order from left to right.

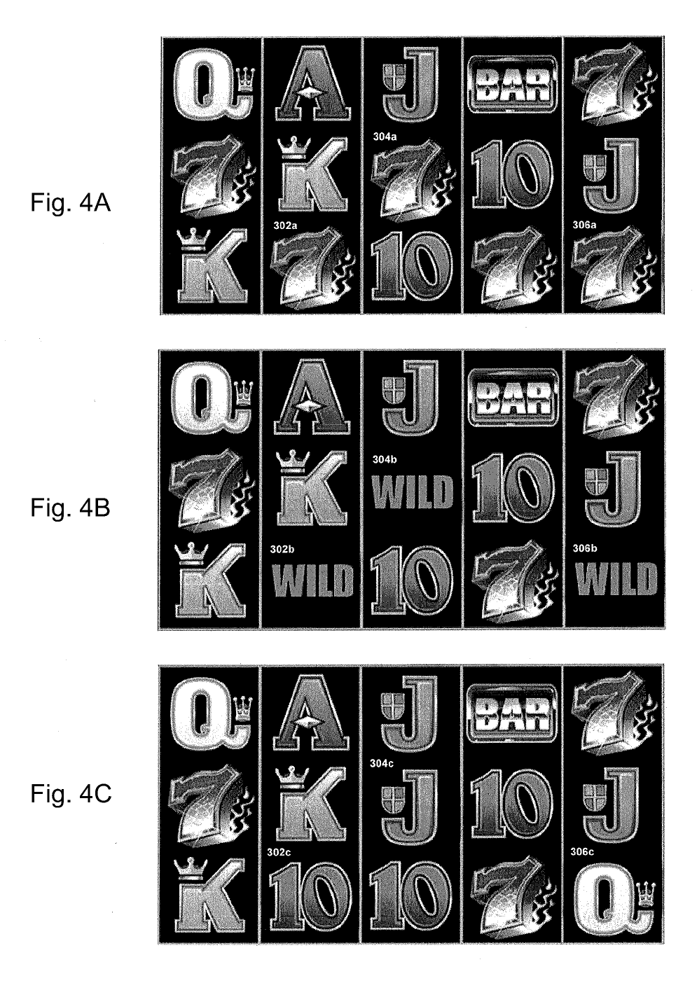

Referring back to FIG. 2, the special bonus symbols 102, 104 and 106 are replaced by the symbols in the final selected segment 204. For example, referring again to FIG. 3, if segment 204a (“7”, “7”, “7”), is the final selected segment, then the resulting display for the bonus game is illustrated in FIG. 4A. In FIG. 4A, reel symbols 302a, 304a and 306a, which were initially special bonus symbols (see FIG. 2: 102, 104, 106), are replaced by the first, second and third symbol (i.e. “7”, “7”, “7”) on the final selected wheel segment 204a, respectively.

It is also possible to have other symbols on the wheel than reel symbols. For example, the wheel may include wild symbols “WILD”. If segment 204b, containing “WILD”, “WILD”, “WILD”, is the final selected segment, then the resulting display is illustrated in FIG. 4B. In FIG. 4B, reel symbols 302b, 304b, and 306b, which were initially special bonus symbols, are replaced by the first, second and third symbol (i.e. “WILD”, “WILD”, “WILD”) on the final selected wheel segment, respectively. One skilled in the art understands that the “WILD” symbols may represent any reel symbol when a corresponding base game result is determined.

The preceding examples were based on FIG. 2, where each segment 204 of the wheel 202 illustrated segments 204 with three of the same reel symbols. However, it is possible for a segment to have different reels symbols. For example, if a segment (not shown) containing the reel symbols “10”, “J”, “Q” is the final selected segment, then the resulting display for bonus game is illustrated in FIG. 4C. In FIG. 4C, reel symbols 302c, 304c, and 306c, which were initially special bonus symbols, are replaced by the first, second and third symbols (i.e. “10”, “J”, “Q”) on the final selected wheel segment, respectively.

As described above, the number of reel symbols in each wheel segment is equal to the number of special bonus symbols in the final base game display. If four special bonus symbols are displayed on the final base game display, then when the wheel is dynamically created, four reel symbols are placed in each segment of the wheel. After spinning the four reel symbols in the final selected segment are substituted for the four special bonus symbols in the base game display screen.

Once the substitutions are made for the special bonus symbols, as described above, then the modified display screen representing the bonus game result is again scanned to determine whether there are any wins. The base game results are evaluated again, to determine which one is the same as the bonus game result. If wild symbols are placed in the bonus game result, there may be more than one base game result which is the same as the bonus game result. Those base game results correspond to the bonus game result. The base game amount associated with the corresponding base game results are paid to the player. The player may then play another base game, if desired.

The preceding example was based on awarding a bonus game to a player if three or more special bonus symbols are displayed at the end of the play of a base game. In one embodiment, in order to award a bonus game, those three special bonus symbols must be along a win line. In another embodiment, it is possible to award a bonus game in response to the appearance of three or more special bonus symbols anywhere on the base game display, sometimes called a scatter. In this embodiment, only a single reel symbol is placed in each wheel segment. When the wheel is spun and stopped, the reel symbol in the final selected segment is substituted for all of the special bonus symbols.

Environment

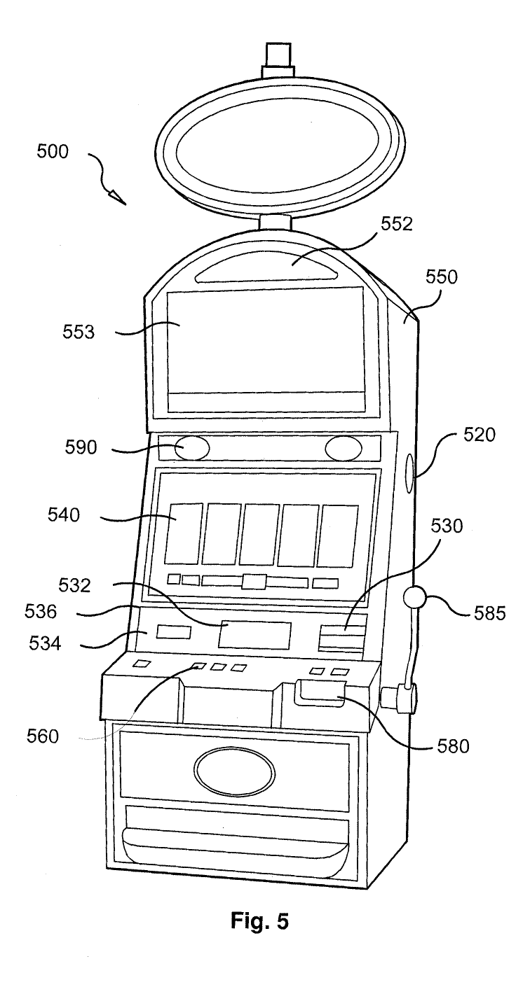

Referring to FIG. 5, gaming machine 500 capable of supporting various embodiments of the invention is shown, including cabinet housing 520, primary game display 540 upon which a primary game and feature game may be displayed, top box 550 which may display multiple progressives that may be won during play of the feature game, player-activated buttons 560, player tracking panel 536, bill/voucher acceptor 580 and one or more speakers 590. Cabinet housing 520 may be a self-standing unit that is generally rectangular in shape and may be manufactured with reinforced steel or other rigid materials which are resistant to tampering and vandalism. Cabinet housing 520 may alternatively be a handheld device including the gaming functionality as discussed herein and including various of the described components herein. For example, a handheld device may be a cell phone, personal data assistant, or laptop or tablet computer, each of which may include a display, a processor, and memory sufficient to support either stand-alone capability such as gaming machine 500 or thin client capability such as that incorporating some of the capability of a remote server. As another example, the cabinet housing 520 may be a personal computer, in any configuration such as a laptop or desktop or tower configuration. Such a personal computer includes a keyboard, mouse or touchpad or trackball, one or more display monitors, one or more processors, and memory sufficient to support the stand-alone capability of a gaming machine or of a thin client.

In one or more embodiments, cabinet housing 520 houses a processor, circuitry, and software (not shown) for receiving signals from the player-activated buttons 560, operating the games, and transmitting signals to the respective displays and speakers. Any shaped cabinet may be implemented with any embodiment of gaming machine 500 so long as it provides access to a player for playing a game. For example, cabinet 520 may comprise a slant-top, bar-top, or table-top style cabinet, including a Bally Cinevision™ or CineReels™ cabinet. The operation of gaming machine 500 is described more fully below.

The plurality of player-activated buttons 560 may be used for various functions such as, but not limited to, selecting a wager denomination, selecting a game to be played, selecting a wager amount per game, initiating a game, or cashing out money from gaming machine 500. Buttons 560 may be operable as input mechanisms and may include mechanical buttons, electromechanical buttons or touch screen buttons. Optionally, a handle 585 may be rotated by a player to initiate a game.

In one or more embodiments, buttons 560 may be replaced with various other input mechanisms known in the art such as, but not limited to, a touch screen system, touch pad, track ball, mouse, switches, toggle switches, or other input means used to accept player input such as a Bally iDeck™. One other example input means is a universal button module as disclosed in U.S. application Ser. No. 11/106,212, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of credits to bet per hand.

Cabinet housing 520 may optionally include top box 550 which contains “top glass” 552 comprising advertising or payout information related to the game or games available on gaming machine 500. Player tracking panel 536 includes player tracking card reader 534 and player tracking display 532. Voucher printer 530 may be integrated into player tracking panel 536 or installed elsewhere in cabinet housing 520 or top box 550.

Game display 540 may present a game of chance wherein a player receives one or more outcomes from a set of potential outcomes. For example, one such game of chance is a video slot machine game. In other aspects of the invention, gaming machine 500 may present a video or mechanical reel slot machine, a video keno game, a lottery game, a bingo game, a Class II bingo game, a roulette game, a craps game, a blackjack game, a mechanical or video representation of a wheel game or the like.

Mechanical or video/mechanical embodiments may include game displays such as mechanical reels, wheels, or dice as required to present the game to the player. In video/mechanical or pure video embodiments, game display 540 is, typically, a CRT or a flat-panel display in the form of, but not limited to, liquid crystal, plasma, electroluminescent, vacuum fluorescent, field emission, or any other type of panel display known or developed in the art. Game display 540 may be mounted in either a “portrait” or “landscape” orientation and be of standard or “widescreen” dimensions (i.e., a ratio of one dimension to another of at least 16×9). For example, a widescreen display may be 32 inches wide by 18 inches tall. A widescreen display in a “portrait” orientation may be 32 inches tall by 18 inches wide. Additionally, game display 540 preferably includes a touch screen or touch glass system (not shown) and presents player interfaces such as, but not limited to, credit meter (not shown), win meter (not shown) and touch screen buttons (not shown). An example of a touch glass system is disclosed in U.S. Pat. No. 6,942,571, entitled “Gaming Device with Direction and Speed Control of Mechanical Reels Using Touch Screen,” which is hereby incorporated by reference in its entirety for all purposes.

Game display 540 may also present information such as, but not limited to, player information, advertisements and casino promotions, graphic displays, news and sports updates, or even offer an alternate game. This information may be generated through a host computer networked with gaming machine 500 on its own initiative or it may be obtained by request of the player using either one or more of the plurality of player-activated buttons 560; the game display itself if game display 540 comprises a touch screen or similar technology; buttons (not shown) mounted about game display 540 which may permit selections such as those found on an ATM machine, where legends on the screen are associated with respective selecting buttons; or any player input device that offers the required functionality.

Cabinet housing 520 incorporates a single game display 540. However, in alternate embodiments, cabinet housing 520 or top box 550 may house one or more additional displays 553 or components used for various purposes including additional game play screens, animated “top glass,” progressive meters or mechanical or electromechanical devices (not shown) such as, but not limited to, wheels, pointers or reels. The additional displays mayor may not include a touch screen or touch glass system.

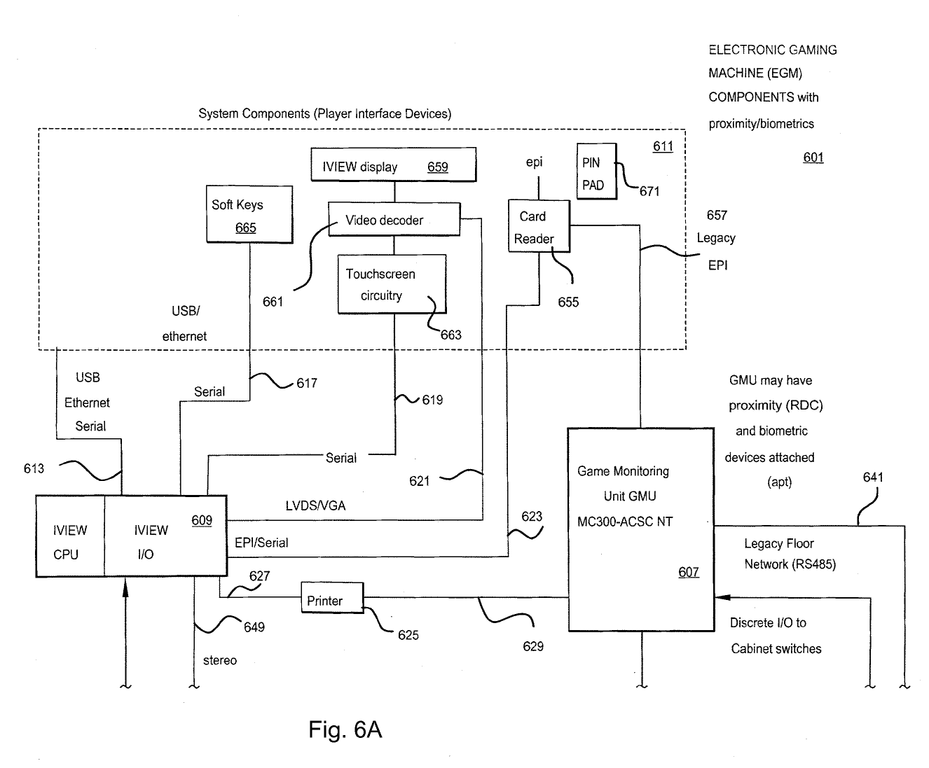

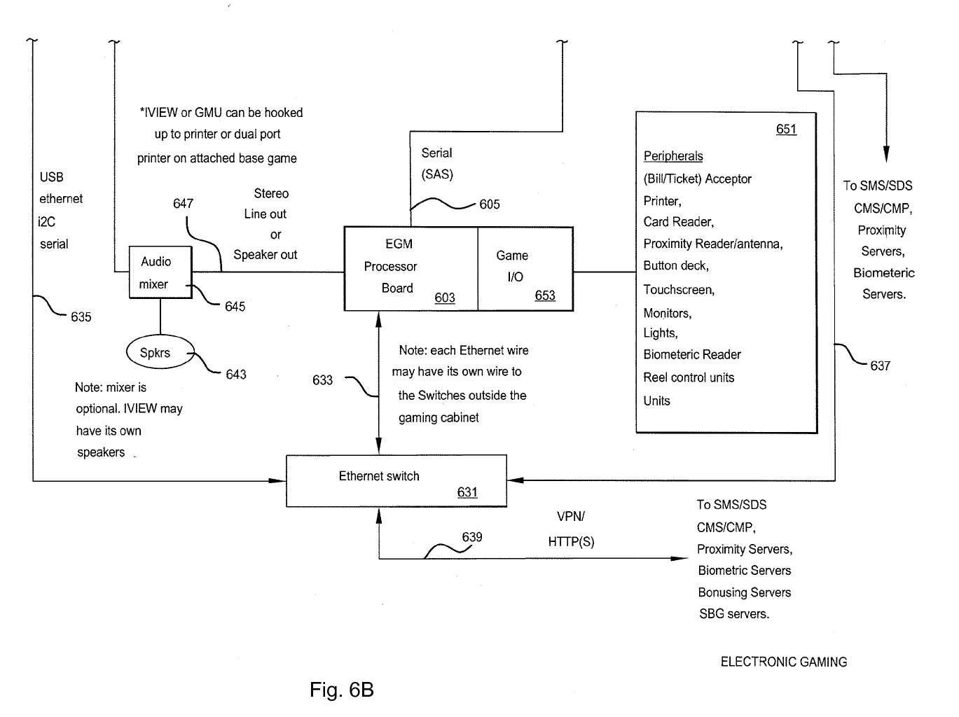

Referring to FIGS. 6A and 6B, electronic gaming machine 601 is shown in accordance with one or more embodiments. Electronic gaming machine 601 includes base game integrated circuit board 603 (EGM Processor Board) connected through serial bus line 605 to game monitoring unit (GMU) 607 (such as a Bally MC300 or ACSC NT), and player interface integrated circuit board (PIB) 609 connected to player interface devices 611 over bus lines 613, 617, 619, 621 and 623, respectively. Printer 625 is connected to PIB 609 and GMU 607 over bus lines 627 and 629, respectively. Base game integrated circuit board 603, PIB 609, and GMU 607 connect to Ethernet switch 631 over bus lines 633, 635 and 637, respectively. Ethernet switch 631 connects to a slot management system (SMS) and a casino management system (CMS) network over bus line 639. GMU 607 also may connect to the SMS and CMS network over bus line 641. Speakers 643 connect through audio mixer 645 and bus lines 647 and 649 to base game integrated circuit board 603 and PIB 609, respectively. Proximity and biometric devices and circuitry may be installed by upgrading a commercially available PIB 609, such as a Bally iView unit. Coding executed on base game integrated circuit board 603, PIB 609, and/or GMU 607 may be upgraded to integrate a game having adjustable multi-part indicia as is more fully described herein.

Peripherals 651 connect through I/O board 653 to base game integrated circuit board 603. For example, a bill/ticket acceptor is typically connected to a game input-output board 653 which is, in turn, connected to a conventional central processing unit (“CPU”) base game integrated circuit board 603, such as an Intel Pentium microprocessor mounted on a gaming motherboard. The I/O board 653 may be connected to base game integrated circuit board 603 by a serial connection such as RS-232 or USB or may be attached to the processor by a bus such as, but not limited to, an ISA bus, or by direct connections to the base game integrated circuit board 603 as a daughter board. The gaming motherboard may be mounted with other conventional components, such as are found on conventional personal computer motherboards, and loaded with a game program which may include a gaming machine operating system (OS), such as a Bally Alpha as. Base game integrated circuit board 603 executes a game program that causes base game integrated circuit board 603 to playa game. In one embodiment, the game program provides a slot machine game having adjustable multi-part indicia. The various components and included devices may be installed with conventionally and/or commercially available components, devices, and circuitry into a conventional and/or commercially available gaming machine cabinet, examples of which are described above.

When a player has inserted a form of currency such as, for example and without limitation, paper currency, coins or tokens, cashless tickets or vouchers, electronic funds transfers or the like into the currency acceptor, a signal is sent by way of I/O board 653 to base game integrated circuit board 603 which, in turn, assigns an appropriate number of credits for play in accordance with the game program. The player may further control the operation of the gaming machine by way of other peripherals 651, for example, to select the amount to wager via electromechanical or touch screen buttons. The game starts in response to the player operating a start mechanism such as a handle or touch screen icon. The game program includes a random number generator to provide a display of randomly selected indicia on one or more displays. In some embodiments, the random generator may be physically separate from gaming machine 600; for example, it may be part of a central determination host system which provides random game outcomes to the game program. Thereafter, the player mayor may not interact with the game through electromechanical or touch screen buttons to change the displayed indicia. Finally, base game integrated circuit board 603 under control of the game program and as compares the final display of indicia to a pay table. The set of possible game outcomes may include a subset of outcomes related to the triggering of a feature game. In the event the displayed outcome is a member of this subset, base game integrated circuit board 603, under control of the game program and by way of I/O Board 653, may cause feature game play to be presented on a feature display.

Predetermined payout amounts for certain outcomes, including feature game outcomes, are stored as part of the game program. Such payout amounts are, in response to instructions from base game integrated circuit board 603, provided to the player in the form of coins, credits or currency via I/O board 653 and a pay mechanism, which may be one or more of a credit meter, a coin hopper, a voucher printer, an electronic funds transfer protocol or any other payout means known or developed in the art.

In various embodiments, the game program is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The gaming machine may access the remote storage device via a network connection, including but not limited to, a local area network connection, a wide area network (possibly including the Internet), a TCP/IP connection, a wireless connection, or any other means for operatively networking components together. Optionally, other data including graphics, sound files and other media data for use with the EGM are stored in the same or a separate memory device (not shown). Some or all of the game program and its associated data may be loaded from one memory device into another, for example, from flash memory to read/write (random access) memory (RAM).

In one or more embodiments, peripherals may be connected to the system over Ethernet connections directly to the appropriate server or tied to the system controller inside the EGM using USB, serial or Ethernet connections. Each of the respective devices may have upgrades to their firmware utilizing these connections.

GMU 607 includes an integrated circuit board and GMU processor and memory including coding for network communications, such as the G2S (game-to-system) protocol promulgated by Gaming Standards Association, Las Vegas, Nev., used for system communications over the network. As shown, GMU 607 may connect to card reader 655 through bus 657 and may thereby obtain player card information and transmit the information over the network through bus 641. Gaming activity information may be transferred by the base game integrated circuit board 603 to GMU 607 where the information may be translated into a network protocol, such as S2S, for transmission to a server, such as a player tracking server, where information about a player's playing activity may be stored in a designated server database.

PIB 609 includes an integrated circuit board, PID processor, and memory which includes an operating system, such as Windows CE, a player interface program which may be executable by the PID processor and various input/output (I/O) drivers for respective devices which connect to PIB 609. These devices include player interface devices 611. The PIB 609 may further include various games or game components playable on PIB 609 or playable on a connected network server for which PB 609 is operable as the player interface. PIB 609 connects to card reader 655 through bus 623, display 659 through video decoder 661 and bus 621, such as an LVDS or VGA bus.

As part of its programming, the PID processor executes coding to drive display 659 to provide messages and information to a player. Touch screen circuitry 663 interactively couples display 659 and video decoder 661 to PIB 609, such that a player may input information and cause the information to be transmitted to PIB 609 via the touch screen 663 either on the player's initiative or responsive to a query by PIB 609. Additionally soft keys 665 connect through bus 617 to PIB 609 and operate together with display 659 to provide information or queries to a player and receive responses or queries from the player. PIB 609, in turn, communicates over the CMS/SMS network through Ethernet switch 631 and busses 635, 639 and with respective servers, such as a player tracking server.

Player interface devices 611 are linked into the virtual private network of the system components in gaming machine 601. The system components include the iView processing board and game monitoring unit (GMU) processing board. These system components may connect over a network to the slot management system (such as a commercially available Bally SDS/SMS) and/or casino management system (such as a commercially available Bally CMP/CMS).

The GMU system component has a connection to the base game through a serial SAS connection 605 and is connected to various servers using, for example, HTTPs over Ethernet. Through this connection, firmware, media, operating system software, gaming machine configurations can be downloaded to the system components from the servers. This data is authenticated prior to install on the system components.

The system components include the iView processing board and game monitoring unit (GMU) processing board. The GMU and iView can combined into one like the commercially available Bally GTM iView device. This device may have a video mixing technology to mix the EGM processor's video signals with the iView display onto the top box monitor or any monitor on the gaming device.

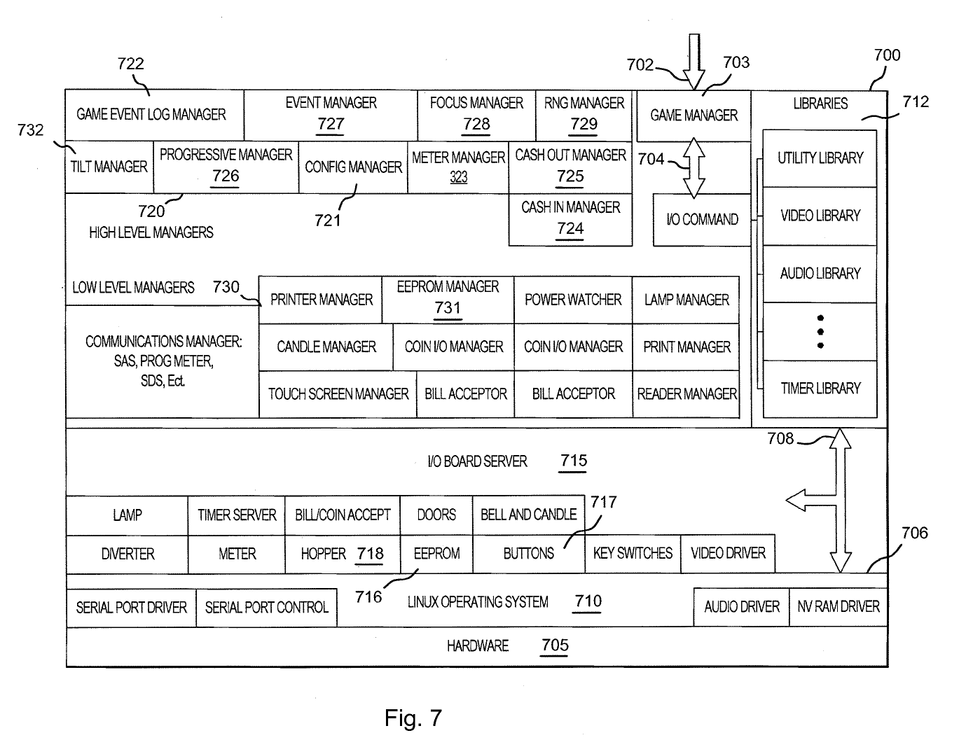

In accordance with one or more embodiments, FIG. 7 is a functional block diagram of a gaming kernel 700 of a game program under control of base game integrated circuit board 603 (FIG. 6). The game program uses gaming kernel 700 by calling into application programming interface (API) 702, which is part of game manager 703. The components of game kernel 700 as shown in FIG. 7 are only illustrative, and should not be considered limiting. For example, the number of managers may be changed, additional managers may be added or some managers may be removed without deviating from the scope and spirit of the invention.

As shown in the example, there are three layers: a hardware layer 705; an operating system layer 710, such as, but not limited to, Linux; and a game kernel layer 700 having game manager 703 therein. In one or more embodiments, the use of a standard operating system 710, such a UNIX-based or Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel layer 700 executes at the user level of the operating system 710, and itself contains a major component called the I/O Board Server 715. To properly set the bounds of game application software (making integrity checking easier), all game applications interact with gaming kernel 700 using a single API 702 in game manager 703. This enables game applications to make use of a well-defined, consistent interface, as well as making access points to gaming kernel 700 controlled, where overall access is controlled using separate processes.

For example, game manager 703 parses an incoming command stream and, when a command dealing with I/O comes in (arrow 704), the command is sent to an applicable library routine 712. Library routine 712 decides what it needs from a device, and sends commands to I/O Board Server 715 (see arrow 708). A few specific drivers remain in operating system 710's kernel, shown as those below line 706. These are built-in, primitive, or privileged drivers that are (i) general (ii) kept to a minimum and (iii) are easier to leave than extract. In such cases, the low-level communications is handled within operating system 710 and the contents passed to library routines 712.

Thus, in a few cases library routines may interact with drivers inside operating system 710, which is why arrow 708 is shown as having three directions (between library utilities 712 and I/O Board Server 715, or between library utilities 712 and certain drivers in operating system 710). No matter which path is taken, the logic needed to work with each device is coded into modules in the user layer of the diagram. Operating system 710 is kept as simple, stripped down, and common across as many hardware platforms as possible. The library utilities and user-level drivers change as dictated by the game cabinet or game machine in which it will run. Thus, each game cabinet or game machine may have an base game integrated circuit board 603 (FIG. 6) connected to a unique, relatively dumb, and as inexpensive as possible I/O adapter board 640, plus a gaming kernel 700 which will have the game-machine-unique library routines and I/O Board Server 715 components needed to enable game applications to interact with the gaming machine cabinet. Note that these differences are invisible to the game application software with the exception of certain functional differences (i.e., if a gaming cabinet has stereo sound, the game application will be able make use of API 702 to use the capability over that of a cabinet having traditional monaural sound).

Game manager 703 provides an interface into game kernel 700, providing consistent, predictable, and backwards compatible calling methods, syntax, and capabilities by way of game application API 702. This enables the game developer to be free of dealing directly with the hardware, including the freedom to not have to deal with low-level drivers as well as the freedom to not have to program lower level managers 730. The lower level managers 730 may be accessed through game manager 703's interface 702 if a programmer has the need. In addition to the freedom derived from not having to deal with the hardware level drivers and the freedom of having consistent, callable, object-oriented interfaces to software managers of those components (drivers), game manager 703 provides access to a set of high level managers 720 also having the advantages of consistent callable, object-oriented interfaces, and further providing the types and kinds of base functionality required in casino-type games. Game manager 703, providing all the advantages of its consistent and richly functional interface 702 as supported by the rest of game kernel 700, thus provides a game developer with a multitude of advantages.

Game manager 703 may have several objects within itself, including an initialization object (not shown). The initialization object performs the initialization of the entire game machine, including other objects, after game manager 703 has started its internal objects and servers in appropriate order. In order to carry out this function, the kernel's configuration manager 721 is among the first objects to be started; configuration manager 721 has data needed to initialize and correctly configure other objects or servers.

The upper level managers 720 of game kernel 700 may include game event log manager 722 which provides, at the least, a logging or logger base class, enabling other logging objects to be derived from this base object. The logger object is a generic logger; that is, it is not aware of the contents of logged messages and events. The log manager's (722) job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 723 manages the various meters embodied in the game kernel 700. This includes the accounting information for the game machine and game play. There are hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 723 receives its initialization data for the meters, during start-up, from configuration manager 721. While running, the cash in (724) and cash out (725) managers call the meter manager's (723) update functions to update the meters. Meter manager 723 will, on occasion, create backup copies of the soft meters by storing the soft meters' readings in EEPROM. This is accomplished by calling and using the low level 730 EEPROM manager 731.

In accordance with still other embodiments, progressive manager 726 manages progressive games playable from the game machine. Event manager 727 is generic, like log manager 722, and is used to manage various gaming machine events. Focus manager 728 correlates which process has control of various focus items. Tilt manager 732 is an object that receives a list of errors (if any) from configuration manager 721 at initialization, and during game play from processes, managers, drivers, etc. that may generate errors. Random number generator manager 729 is provided to allow easy programming access to a random number generator (RNG), as a RNG is required in virtually all casino-style (gambling) games. RNG manager 729 includes the capability of using multiple seeds.

In accordance with one or more embodiments, a credit manager object (not shown) manages the current state of credits (cash value or cash equivalent) in the game machine, including any available winnings, and further provides denomination conversion services. Cash out manager 725 has the responsibility of configuring and managing monetary output devices. During initialization, cash out manager 725, using data from configuration manager 721, sets the cash out devices correctly and selects any selectable cash out denominations. During play, a game application may post a cash out event through the event manager 727 (the same way all events are handled), and using a call-back posted by cash out manager 725, cash out manager 725 is informed of the event. Cash out manager 725 updates the credit object, updates its state in non-volatile memory, and sends an appropriate control message to the device manager that corresponds to the dispensing device. As the device dispenses dispensable media, there will typically be event messages being sent back and forth between the device and cash out manager 725 until the dispensing finishes, after which cash out manager 725, having updated the credit manager and any other game state (such as some associated with meter manager 723) that needs to be updated for this set of actions, sends a cash out completion event to event manager 727 and to the game application thereby. Cash in manager 724 functions similarly to cash out manager 725, only controlling, interfacing with, and taking care of actions associated with cashing in events, cash in devices, and associated meters and crediting.

In a further example, in accordance with one or more embodiments, I/O server 715 may write data to the gaming machine EEPROM memory, which is located in the gaming machine cabinet and holds meter storage that must be kept even in the event of power failure. Game manager 703 calls the I/O library functions to write data to the EEPROM. The I/O server 715 receives the request and starts a low priority EEPROM thread 716 within I/O server 715 to write the data. This thread uses a sequence of 8 bit command and data writes to the EEPROM device to write the appropriate data in the proper location within the device. Any errors detected will be sent as IPC messages to game manager 703. All of this processing is asynchronous.

In accordance with one embodiment, button module 717 within I/O server 715, polls (or is sent) the state of buttons every 2 ms. These inputs are debounced by keeping a history of input samples. Certain sequences of samples are required to detect a button was pressed, in which case the I/O server 715 sends an inter-process communication (IPC) event to game manager 703 that a button was pressed or released. In some embodiments, the gaming machine may have intelligent distributed I/O which debounces the buttons, in which case button module 717 may be able to communicate with the remote intelligent button processor to get the button events and simply relay them to game manager 703 via IPC messages. In still another embodiment, the I/O library may be used for payout requests from the game application. For example, hopper module 718 must start the hopper motor, constantly monitor the coin sensing lines of the hopper, debounce them, and send an IPC message to the game manager 703 when each coin is paid.

Further details, including disclosure of lower level fault handling and/or processing, are included in U.S. Pat. No. 7,351,151 entitled “Gaming Board Set and Gaming Kernel for Game Cabinets” and provisional U.S. patent application No. 60/313,743, entitled “Form Fitting Upgrade Board Set For Existing Game Cabinets,” filed Aug. 20, 2001; said patent and provisional are both fully incorporated herein by explicit reference.

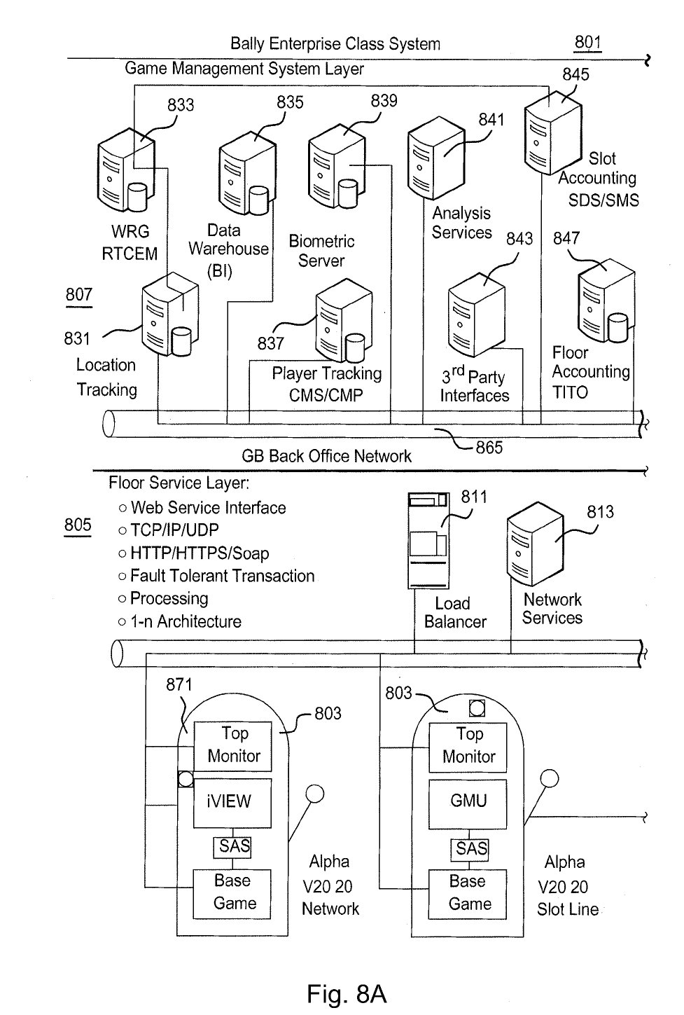

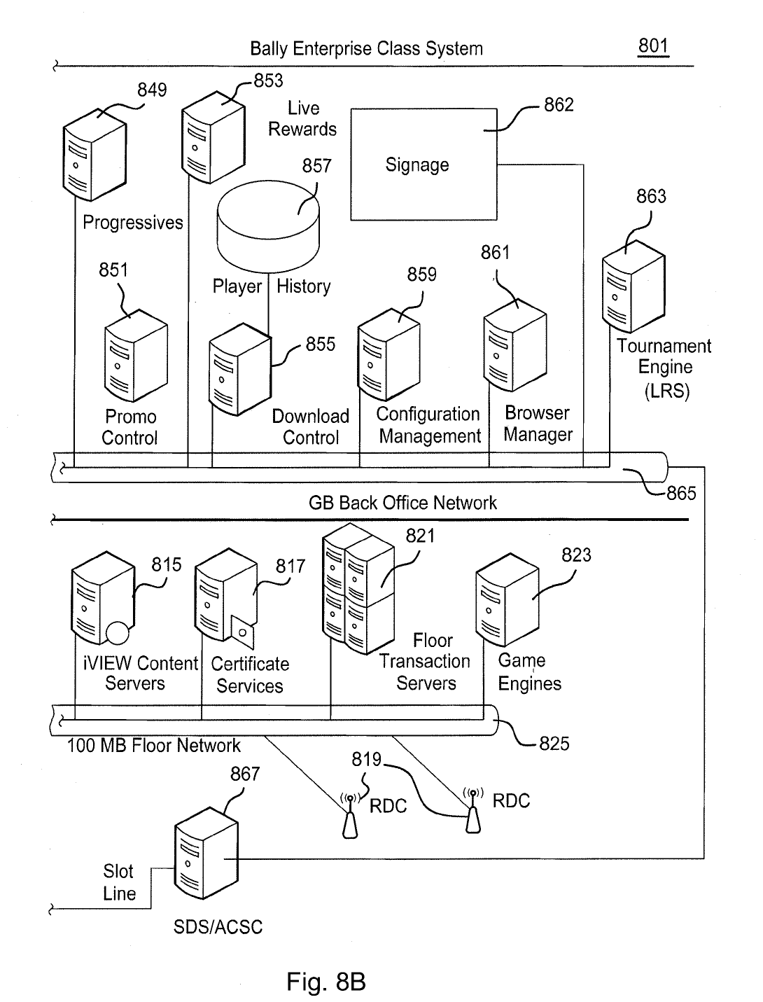

Referring to FIGS. 8A and 8B, enterprise gaming system 801 is shown in accordance with one or more embodiments. Enterprise gaming system 801 may include one casino or multiple locations and generally includes a network of gaming machines 803, floor management system (SMS) 805, and casino management system (CMS) 807. SMS 805 may include load balancer 811, network services servers 813, player interface (iView) content servers 815, certificate services server 817, floor radio dispatch receiver/transmitters (RDC) 819, floor transaction servers 821 and game engines 823, each of which may connect over network bus 825 to gaming machines 803.

CMS 807 may include location tracking server 831, WRG RTCEM server 833, data warehouse server 835, player tracking server 837, biometric server 839, analysis services server 841, third party interface server 843, slot accounting server 845, floor accounting server 847, progressives server 849, promo control server 851, feature game (such as Bally Live Rewards) server 853, download control server 855, player history database 857, configuration management server 859, browser manager 861, tournament engine server 863 connecting through bus 865 to server host 867 and gaming machines 803.

The various servers and gaming machines 803 may connect to the network (825, 865) with various conventional network connections (such as, for example, USB, serial, parallel, RS485, Ethernet). Additional servers which may be incorporated with CMS 807 include a responsible gaming limit server (not shown), advertisement server (not shown), and a control station server (not shown) where an operator or authorized personnel may select options and input new programming to adjust each of the respective servers and gaming machines 803. SMS 805 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

Gaming machines 803 include various peripheral components that may be connected with USB, serial, parallel, RS-485 or Ethernet devices/architectures to the system components within the respective gaming machine. The GMU has a connection to the base game through a serial SAS connection. The system components in the gaming cabinet may be connected to the servers using HTTPs or G2S over Ethernet. Using CMS 807 and/or SMS 805 servers and devices, firmware, media, operating systems, and configurations may be downloaded to the system components of respective gaming machines for upgrading or managing floor content and offerings in accordance with operator selections or automatically depending upon CMS 807 and SMS 805 master programming. The data and programming updates to gaming machines 803 are authenticated using conventional techniques prior to install on the system components.

In various embodiments, any of the gaming machines 803 may be a mechanical reel spinning slot machine or a video slot machine or a gaming machine offering one or more of the above described games including a group play game. Alternately, gaming machines 803 may provide a game with a simulated musical instrument interface as a primary or base game or as one of a set of multiple primary games selected for play by a random number generator. A gaming system of the type described above also allows a plurality of games in accordance with the various embodiments of the invention to be linked under the control of a group game server (not shown) for cooperative or competitive play in a particular area, carousel, casino or between casinos located in geographically separate areas. For example, one or more examples of group games under control of a group game server are disclosed in U.S. application Ser. No. 11/938,079, entitled “Networked System and Method for Group Play Gaming,” filed on Nov. 9, 2007, which is hereby incorporated by reference in its entirety for all purposes.

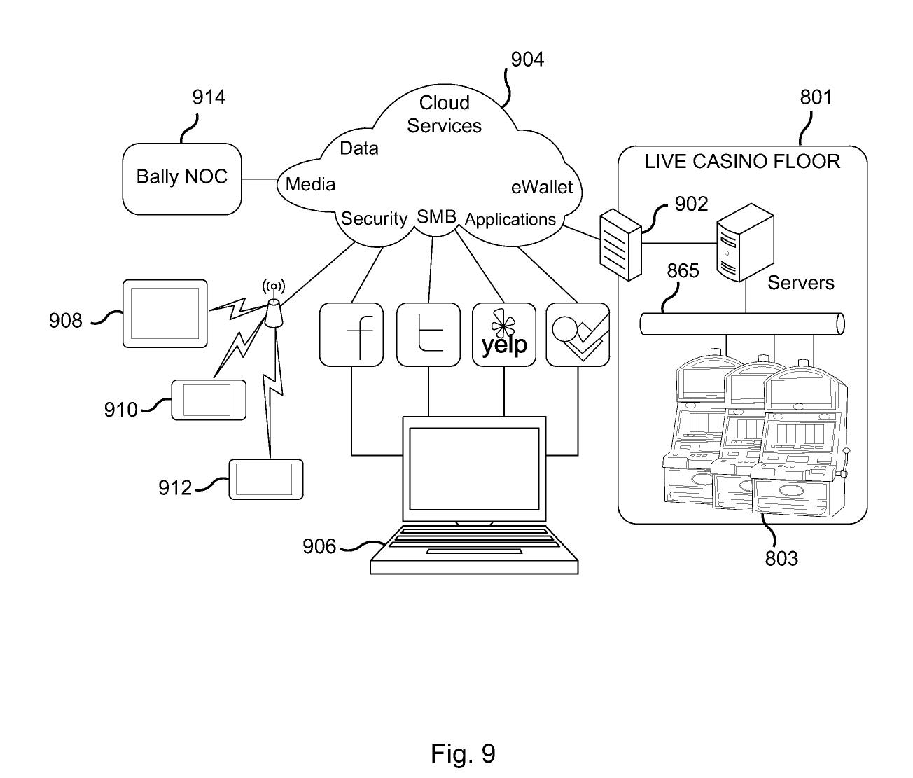

All or portions of the present invention may also be implemented by or promoted through a system as suggested in FIG. 9. The gaming system 801 (illustrated in detail in FIG. 8), may be hosted at a casino property enterprise, across several casino enterprises or by a third party host. As described above, the gaming system 801 has a network communication bus 865 providing communication between the gaming terminals 803 and various servers. To provide the functionality illustrated in FIG. 9, a bonusing server 900, such as a Bally Elite Bonusing Server is connected to the network communication bus 865 for communication to the gaming system 801, the gaming terminals 803 and the various servers and other devices as described above. The bonusing server 900 is in communication with a cloud computing/storage service 904 through a secure network firewall 902. The cloud computing/storage service 904 may be hosted by the casino enterprise, a licensed third party or if permitted by gaming regulators an unlicensed provider. For example the cloud service 904 may be as provided by Microsoft® Private Cloud Solutions offered by Microsoft Corp. of Redmond, Wash., USA. The cloud service 904 provides various applications which can be accessed by and delivered to, for example, personal computers 906, portable computing devices such as computer tablets 908, personal digital assistants (PDAs) 910 and cellular devices 912 such as telephones and smart phones. As an example, the cloud service 904 may store and host: (a) an eWallet application, (b) a casino or player-centric applications such as downloadable or accessible applications including games, promotional material or applications directed to and/or affecting a casino customers interaction with a casino enterprise (such as accessing the players casino account, establishing casino credit or the like), (c) providing bonuses to players through system wide bonusing (SMB) or specific bonusing or comps to players, or (d) other applications. The cloud service 904 includes security to provide for secure communication within the cloud service 904, between the player/users and the cloud service 904, and between the cloud service 904 and the gaming system 801. Security applications may be through encryption, the use of personal identification numbers (PINS) or other devices and systems. As suggested in FIG. 9, the cloud service 904 stores player/user data retrieved from players/users and from the gaming system 801.

The players/users may access the cloud service 904 and the applications and data provided thereby through the Internet or through broadband wireless cellular communication systems and any intervening short range wireless communication such as Bluetooth® (a registered trademark of Bluetooth SIG, Inc.) or WiFi. The players/users may further access the applications and data through various social media offerings such as Facebook, Twitter, Yelp, MySpace, LinkedIn or the like.

As but an example, a player/user may have a player account with a casino enterprise Z. That account may include data such as the player's credit level, their rating and their available comps. The account may further track any certificates, and the present value thereof, the player may have won as a result of the playing a game according to the present invention. At their smart phone 912 the player/user sends a request to the cloud service 904 (perhaps through a previously downloaded application) to receive the status of their available comps such as how many comp points they have and what may be available through redemption of those points (e.g. lodging, cash back, meals or merchandise). The response to the request may present casino promotions, graphics or other advertising to the player/user. The application, to support such a request, would typically require the player/user to enter a PIN. The cloud service 904 forwards the inquiry to the bonusing servicer 900 which, in turn, confirms the PIN and retrieves the requested information from the data warehouse 835 (FIG. 8) or player tracking CMS/CMP server 837.

Alternatively the data may be stored in the cloud service 904 and routinely updated from the data warehouse 835 or player tracking CMS/CMP server 837. In this instance the request would be responded to from data residing with the cloud service 904. The information is formatted by the cloud server 904 application and delivered to the player/user. The delivery may be formatted based upon the player/user's device operating system (OS), display size or the like.

The cloud service 904 may also host game applications to provide virtual instances of games for free, promotional, or where permitted, P2P (Pay to Play) supported gaming. Third party developers may also have access to placing applications with the cloud service 904 through, for example a national operations center (for example, Bally NOC 914). A game software manufacturer such as Bally Gaming, Inc. may also provide game applications on its own or on behalf of the casino enterprise.

Other media such as advertising, notices (such as an upcoming tournament) may also be provided to the cloud service 904. When a player/user accesses the cloud service 904 certain media may be delivered to the player/user in a manner formatted for their application and device.

Although the description above contains many specificities, these should not be construed as limiting the scope of the invention but as merely providing an illustration of the presently preferred embodiment of the invention. Thus the scope of this invention should be determined by the appended claims and their legal equivalents.

What is claimed is:

1. A gaming device comprising:
a game initiation device;
a set of base game results, each comprising a predetermined number of symbols including base game symbols and zero or more bonus game symbols, and each associated with a base game award;
a base game randomly selecting a base game result from the set of base game results in response to activation of the game initiation device, and awarding the associated base game result award to a player, and if the base game result includes at least a predetermined number of bonus game symbols, awarding a bonus game to the player;
a bonus game randomly selecting a number of base game symbols equal to the number of bonus game symbols in the base game result and substituting the selected base game symbols for the bonus game symbols in the base game result to produce a bonus game result and awarding the base game award associated with the base game result corresponding to the bonus game result to the player.

2. The gaming device of claim 1 wherein play of the bonus game comprises initiating the bonus game in response to activation of the game initiation device.

3. The gaming device of claim 1 wherein the gaming device further comprises a display device which displays the play of the base game, the base game result, the play of the bonus game and the bonus game result.

4. The gaming device of claim 3 wherein play of the bonus game comprises display of a base game symbol selection image.

5. The gaming device of claim 4 wherein the base game symbol selection image selects one group from a plurality of groups of base game symbols.

6. The gaming device of claim 5 wherein play of the bonus game comprises selection of one group from the plurality of groups in response to activation of the game activation device.

7. The gaming device of claim 4 wherein the base game symbol selection image comprises a plurality of groups of base game symbols, where the number of base game symbols in each group equals the number of bonus game symbols in the base game result.

8. The gaming device of claim 4 wherein the base game symbol selection image is a wheel including a plurality of segments, each segment including a group of base game symbols, and a pointer to the segments, wherein activation of the game activation device starts the wheel spinning, then stops the wheel, wherein the selected base game symbols are those in the segment pointed to by the pointer when the wheel stops.

9. The gaming device of claim 8 wherein the number of base game symbols in each group equals the number of bonus game symbols in the base game result.

10. The gaming device of claim 1 wherein each base game result contains a predetermined number of columns, each column including a predetermined number of symbols.

11. The gaming device of claim 1 wherein each base game result contains five columns, each column including three symbols.

12. The gaming device of claim 1 wherein the predetermined number of bonus game symbols is three bonus game symbols.
